(19) United States
(12) Patent Application Publication
(10) Pub. No.: US 2022/0358469 A1
(43) Pub. Date: Nov. 10, 2022

(54) Vehicular Repair Apparatus and Method

(71) Applicant: Assured Performance Network, Laguna Hills, CA (US)

(72) Inventor: Scott Edwin Biggs, Polson, MT (US)

(21) Appl. No.: 17/308,851

(22) Filed: May 5, 2021

(51) Int. Cl. G06Q 10/00; G06Q 10/08; G06Q 30/02; G06T 7/00

(52) U.S. Cl. CPC G06Q 10/20; G06Q 10/0875; G06Q 30/0284; G06T 7/0004; G06T 2207/30252

(57) ABSTRACT

These teachings provide a statement corresponding to a pending repair of a particular vehicle and securely stores that statement in inviolate electronic storage in correlation with a unique vehicle identifier. Parts are ordered to specifically use to repair this vehicle per that statement and again information regarding those ordered parts is securely stored in the inviolate electronic storage (again in correlation with the unique vehicle identifier). That particular vehicle is repaired using those ordered parts and per the foregoing statement. By one approach that repair proceeds per a series of specified sub-tasks. Information regarding completion of at least some of those specified sub-tasks is securely stored in the inviolate electronic storage, again in correlation with the unique vehicle identifier. These teachings then provide for preparing vehicle repair completion documentation and securely storing information regarding that documentation in the inviolate electronic storage again in correlation with the unique vehicle identifier.

### TECHNICAL FIELD

These teachings relate generally to vehicular repair.

### BACKGROUND

Various vehicles are known in the art, including terrestrial vehicles such as automobiles and trucks. Such vehicles can and do become damaged during use, often as the result of a collision between two or more such vehicles. In many cases it is cost-effective to repair a damaged vehicle rather than replace it.

Vehicular repair often involves many entities and numerous procedures. A typical repair will also include replacing damaged parts with replacement parts. While vehicular repair is often covered, in whole or in part, by insurance, such coverage begs the question regarding the quality of the repair. Were appropriate parts utilized? Were proper repair procedures observed? Were the service technicians properly trained? These and many other concerns often suffer unsatisfactory answers with typical prior art approaches.

### BRIEF DESCRIPTION OF THE DRAWINGS

The above needs are at least partially met through provision of the vehicular repair apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings; and

FIG. 3 comprises a schematic flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments facilitate repairing a particular vehicle (such as a terrestrial vehicle) that has a unique vehicle identifier (such as a so-called vehicle identification number (VIN)) assigned thereto by a manufacturer of that particular vehicle.

By one approach these teachings provide a statement corresponding to a pending repair of that particular vehicle and securely stores that statement in inviolate electronic storage in correlation with that unique vehicle identifier. Parts are then ordered to specifically use to repair this particular vehicle per that statement and again information regarding those ordered parts is securely stored in the inviolate electronic storage (again in correlation with the unique vehicle identifier). These teachings then provide for repairing that particular vehicle using those ordered parts and per the foregoing statement. By one approach that repair proceeds per a series of specified sub-tasks. Information regarding completion of at least some of those specified sub-tasks is securely stored in the inviolate electronic storage, again in correlation with the unique vehicle identifier. These teachings then provide for preparing vehicle repair completion documentation and securely storing information regarding that vehicle repair completion documentation in the inviolate electronic storage again in correlation with the unique vehicle identifier.

So configured, any of the information securely stored in the inviolate electronic storage in correlation with the vehicle identifier can later be at least conditionally accessed to permit a review of the information to thereby assess the repair to the particular vehicle for any of a variety of purposes.

By one approach, the foregoing statement includes, at least in part, at least one estimated repair parameter corresponding to repair of the particular vehicle. That estimated repair parameter may comprise, for example, at least one of an estimated monetary cost of the repair and an estimated time to effect the repair. By one approach, in lieu of the foregoing or in combination therewith, the statement generally comprises, at least in part, a compilation of repair procedures.

By one approach, the aforementioned vehicle repair completion documentation includes, at least in part, a final repair invoice. The latter may document, at least in part, one or more of the parts used to repair the particular vehicle, labor costs to repair the particular vehicle, painting costs associated with repairing the particular vehicle, and miscellaneous sublet charges associated with repairing the particular vehicle. In lieu of the foregoing or in combination therewith, the vehicle repair completion documentation can comprise, at least in part, one or more photographic images of the particular vehicle that depict at least some aspect of the repair and/or the pre-repair vehicle. For example, at least one such photographic image may depict at least some aspect of the repair that evidences attending to a given one of the aforementioned sub-tasks.

So configured, concerned parties (including, for example, the vehicular owner or user, one or more interested insurance companies, and so forth) can be better assured that proper parts and procedures were utilized and observed when repairing a given vehicle, and information evidencing and supporting that assurance is securely stored for near-term or long-term use.

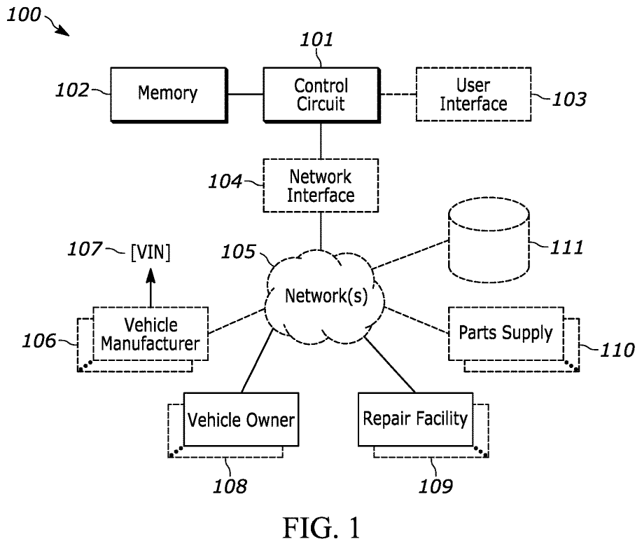

These and other benefits may become clearer upon making a thorough review and study of the following detailed description. Referring now to the drawings, and beginning with FIG. 1, an illustrative apparatus 100 that is compatible with many of these teachings will now be presented.

For the sake of an illustrative example it will be presumed here that a control circuit of choice carries out the actions, steps, and/or functions that are described herein. In this particular example, the enabling apparatus 100 includes such a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101). It will also be understood that the memory 102 may itself be comprised of multiple memory platforms that may or may not share physical space with one another.

In addition to optionally storing part or all of the information described above, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

By one optional approach the control circuit 101 operably couples to a user interface 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

In this example the control circuit 101 also operably couples to a network interface 104. So configured the control circuit 101 can communicate with other elements (both within the apparatus 100 and external thereto) via the network interface 104 and at least one intervening network 105. Numerous examples are known in the art. A non-exhaustive listing would include Universal Serial Bus (USB)-based interfaces, RS232-based interfaces, I.E.E.E. 1394 (aka Firewire)-based interfaces, Ethernet-based interfaces, any of a variety of so-called Wi-Fi™-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces. Such interfaces can be selectively employed to communicatively couple the control circuit 101 to another such control circuit, to a local area network, or to any of a variety of wide area networks or extranets (such as, but not limited to, the Internet) 105.

For the sake of an illustrative example, these teachings presume at least one vehicle manufacturer 106. In this example this vehicle manufacturer 106 manufactures terrestrial vehicles such as automobiles, trucks, vans, recreational vehicles, trailers, and so forth. It shall be understood that these teachings are not limited to terrestrial vehicles, however, and may be successfully applied with respect to, for example, marine vehicles and airborne vehicles. These teachings are similarly applicable regardless of whether the vehicle is wholly or partially human-piloted or capable of autonomous operation.

These teachings also presume that the vehicle manufacturer 106 assigns to at least most vehicles it manufactures a unique vehicle identifier. By one approach, and as used herein as an illustrative example, this unique vehicle identifier can comprise the well-known vehicle identification number (VIN) (also called a chassis number or frame number) used by the automotive industry to identify individual vehicles as defined in International Organization for Standardization (ISO) 3779 and ISO 4030.

Via the aforementioned network 105, these teachings also presume that the aforementioned control circuit 101 can communicate with other relevant entities. Examples include but are not limited to vehicle owners 108 and vehicle repair facilities 109. The latter entities may communicate via any of a variety of devices including, but not limited to, desktop computers, laptop computers, pad/tablet-style devices, and smart phones. Depending upon a particular application setting the control circuit 100 may also communicate with one or more vehicular parts supply facilities 110, insurers (not shown), lessees (not shown), or others as desired.

These teachings will also support the presence and use of one or more cloud-based data storage facilities 111. This data storage facility 111 may comprise at least part of a private or public distributed-ledger block chain-based storage facility. A blockchain is a growing list of records, called blocks, that are linked using cryptography. Each block typically contains a cryptographic hash of the previous block, a timestamp, and transaction data. By design, a blockchain is resistant to modification of its data. Once recorded, the data in any given block cannot be altered retroactively without also requiring alteration of all subsequent blocks. As a result, such a platform is typically regarded as an open, distributed ledger that can record transactions or other information efficiently and yet also in a verifiable and permanent way.

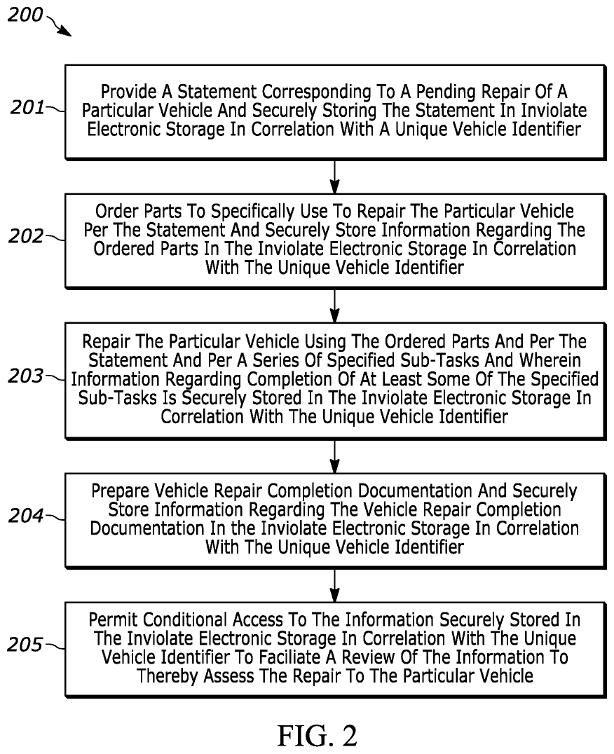

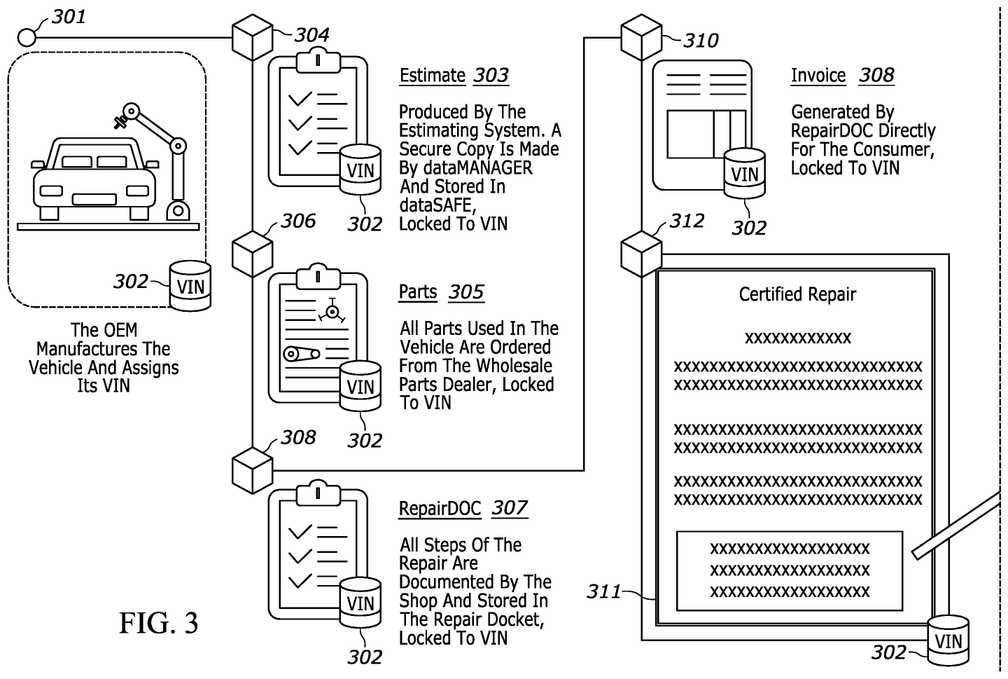

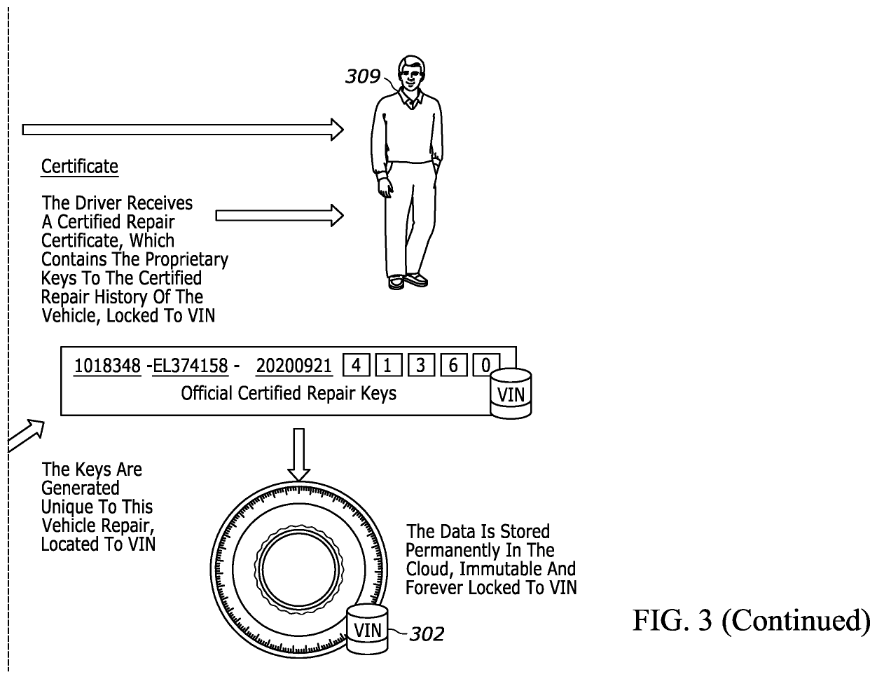

Referring now to FIG. 2, and with continued reference to FIG. 1, a process that can be carried out via the above-described apparatus 100 will be described. This process 200 presumes the presence of a particular vehicle, owned by a vehicle owner 108, that is in need of repair. This need may be owing, for example, to an accidental collision between the particular vehicle and another object, such as another vehicle. In this example this particular vehicle has a corresponding unique vehicle identifier (i.e., a VIN) that the manufacturer of the particular vehicle assigned thereto.

At block 201 of this process 200, these teachings provide a statement corresponding to a pending repair of the particular vehicle. By one approach the above-described control circuit 101 handles this task in whole or in part. By one approach, this statement includes, at least in part, at least one estimated repair parameter corresponding to repair of the particular vehicle. Examples of estimated repair parameters include, but are not limited to, an estimated monetary cost of the repair and an estimated window of time to effect the repair. In many application settings it will be beneficial if the statement comprises, in lieu of the foregoing or in combination therewith, and at least in part, a compilation of specified repair procedures that, when followed and completed, will result in a complete repair of the particular vehicle. If desired, the latter may specify such things as an order in which the complete repair is to proceed, any specific requirements regarding necessary tools and/or the repair environment, and any specific requirements regarding the experience and/or the training of the personnel assigned to effect part or all of the repair.

This statement will typically at least comprise a digital document (or collection of documents) but may also include a hard copy of part or all thereof. This statement may be developed using information provided, for example, by one or more of the repair facilities 109, one or more of the parts suppliers 110, and/or the vehicle manufacturer 106. The control circuit 101 may also have access to its own information in these regards that may be stored, for example, in the aforementioned memory 102. This statement may be developed in a fully or partially-automated manner by the control circuit 101 as desired.

Access to this statement can be provided, in whole or in part, to the vehicle owner 108, the repair facility 109, the parts suppliers 110, and/or to any other appropriate party such as an insurance company that is responsible, at least in part, for covering the repair costs.

These teachings further provide for securely storing the foregoing statement in inviolate electronic storage in correlation with the unique vehicle identifier for the particular vehicle. This storage can comprise use of the aforementioned memory 102 and/or the cloud storage memory 111 described above. In any event, the storage can include use of a block chain ledger to store the statement in a block thereof.

At block 202, this process provides for ordering parts from one or more of the parts suppliers 110 to specifically use to repair the particular vehicle per the foregoing statement. By one approach the above-described statement delineates and specifies the particular parts to be ordered and further specifies the particular repair facility 109 to receive those parts. This order can specify delivery parameters as well if desired, such as delivery time frames and so forth.

These teachings will accommodate a variety of approaches in the foregoing regards. By one approach the order may presume pre-negotiated pricing and other delivery terms. By another approach, the control circuit 101 may request pricing quotes from a plurality of different parts suppliers 110 and select a particular parts supplier 110 offering favorable terms regarding, for example, pricing, delivery timing, and/or availability of parts from a particular desired source.

In any event, information regarding the ordered parts is securely stored in the aforementioned inviolate electronic storage in correlation with the unique vehicle identifier. This storage can include use of a block chain ledger to store the statement in a block thereof.

At block 203, this process 200 provides for repairing the particular vehicle using the ordered parts and per the statement at the corresponding repair facility 109. By one approach the repair process itself proceeds per a series of specified sub-tasks and where information regarding completion of at least some of specified sub-tasks is securely stored in the aforementioned inviolate electronic storage, again in correlation with the unique vehicle identifier. This storage can include use of a block chain ledger to store the statement in a block thereof.

Generally speaking, such information evidences the completion of corresponding sub-tasks. Such information can comprise, for example, digital photographs depicting before and after images of repaired portions of the particular vehicle to thereby illustrate, for example, installation of replacement parts, remediation of dents and the like, and/or painting results. Such information might also include, for example, content that evidences step-by-step procedures for effecting particular repairs.

By one approach, the repair facility 109 communicates the foregoing information that evidences the completion of corresponding sub-tasks to the aforementioned control circuit 101 (possibly following processing regarding content and/or form) which provides for the aforementioned secure storage in the inviolate electronic storage facility.

At block 204, this process 200 provides (for example, via the control circuit 101) for preparing vehicle repair completion documentation which is then also securely stored in the inviolate electronic storage in correlation with the unique vehicle identifier. This storage can include use of a block chain ledger to store the statement in a block thereof.

By one approach this vehicle repair completion documentation includes, at least in part, a final repair invoice. The latter may specify and document, at least in part, parts that were used to repair the particular vehicle, labor costs to repair the particular vehicle, painting costs associated with repairing the particular vehicle, and/or miscellaneous sublet charges associated with repairing the particular vehicle.

This vehicle repair completion documentation may also comprise, in lieu of the foregoing or in combination therewith, at least one photographic image of the particular vehicle that depicts at least some aspect of the repair. As a more specific example in these regards, the at least one photographic image may depict at least some aspect of the repair that evidences attending to a given one of the sub-tasks. By one approach, such image-based evidence is required for each and every sub-task.

As shown at block 205, this process 200 can then provide for permitting conditional access to the information securely stored in the aforementioned inviolate electronic storage in correlation with the unique vehicle identifier to facilitate reviewing that information to thereby assess the repair of the particular vehicle. Such access may be provided, for example, to the vehicle owner 108 and/or to an insurance company as desired.

For the sake of illustration, a particular instantiation of these teachings that accords with the foregoing will now be presented. It will be understood that the details of this example are intended to serve an illustrative purpose and are not intended to suggest any particular limitations with respect to these teachings.

At reference numeral 301, an original equipment manufacturer manufactures a particular vehicle and assigns a VIN 302 to that vehicle. That particular vehicle then undergoes an experience that results in necessitating a corresponding repair (not illustrated). At reference 303, an estimating system of choice produces an estimate as described above. A copy of that estimate is securely stored in combination with the VIN 302 in a block 304 of the aforementioned block chain. At reference 305, the necessary parts to repair the vehicle per the estimate are then ordered. Information regarding that order is stored in a subsequent block 306 of the aforementioned block chain along with the VIN 302.

At reference 307, each step of the repair process is documented as described above by the repair facility and stored, along with the VIN 302, in one or more subsequent blocks 308 of the aforementioned block chain. And at reference 308, the system generates, in this example, an invoice directly for the vehicle owner 309. A copy of that invoice is securely stored in yet another subsequent block 310 of the aforementioned block chain along with the VIN 302.

Also in this example, a certificate 311 attesting to the certified repair is prepared and stored, along with the VIN 302, in yet another block 312 of the aforementioned block chain. That certificate 311 can be pushed to and/or pulled by the owner 309 or other appropriate party as desired. If desired, and as illustrated here, an access and/or encryption key can be generated that is unique to this particular repair. That information can be utilized (for example, by the owner 309) to later access the information stored in the block chain to retrieve any of the information stored therein corresponding to this VIN 302 and/or this repair.

These teachings are highly flexible in practice and will accommodate a variety of modifications and or supplemental activity.

For example, by one approach a particular repair facility 109 can receive from the aforementioned control circuit 101 information that identifies a particular vehicular repair task and that tasks the repair facility with that particular vehicular repair task. In those regards, parsed information can be provided to one or more persons at the repair facility 109 via a mobile device that comprises a plurality of sub-tasks that collectively address the vehicular repair task. The control circuit 101 can then interact with that mobile device to obtain task-completed information regarding completion of each of the plurality of sub-tasks. The latter can include a first image that depicts a first completed one of the plurality of sub-tasks where the aforementioned mobile device presents an image capture opportunity by which the repair facility captures the first image at a time-of-need when providing the task-completed information. The latter can also include a second image that depicts a completed different one of the plurality of sub-tasks where again the mobile device presents an image capture opportunity by which the user captures the second image at a different time-of-need when providing the task-completed information.

As another example, these teachings will support the control circuit 101 receiving information from the repair facility 109 regarding increased costs that were not originally accounted for in an initial estimate as regards at least one sub-task. That information can then be utilized to update the estimate and/or to otherwise reflect and account for such increases when arranging for payment to be provided to the repair facility 109. Less than expected costs can be similarly handled.

So configured, these teachings address numerous prior art problems. Generally speaking, the documented invoicing provided per the foregoing helps ensure quality and accountability while demonstrably improving liability exposure. These teachings can leverage data integration with existing systems to auto-populate system-generated final documentation in conjunction with block chain integrity and security. Those skilled in the art will appreciate that the documentation created and securely stored as described herein can serve as evidence that protects the repair facility, repair technicians, insurer, and other related or necessary parties. It will also be appreciated that this evidentiary value persists over time.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A method to facilitate repairing a particular vehicle having a unique vehicle identifier assigned thereto by a manufacturer of the particular vehicle, the method comprising:
providing a statement corresponding to a pending repair of the particular vehicle and securely storing the statement in inviolate electronic storage in correlation with the unique vehicle identifier;
ordering parts to specifically use to repair the particular vehicle per the statement and securely storing information regarding the ordered parts in the inviolate electronic storage in correlation with the unique vehicle identifier;
repairing the particular vehicle using the ordered parts and per the statement, wherein repairing the particular vehicle proceeds per a series of specified sub-tasks and wherein information regarding completion of at least some of the specified sub-tasks is securely stored in the inviolate electronic storage in correlation with the unique vehicle identifier;
preparing vehicle repair completion documentation and securely storing information regarding the vehicle repair completion documentation in the inviolate electronic storage in correlation with the unique vehicle identifier;
such that any of the information securely stored in the inviolate electronic storage in correlation with the unique vehicle identifier can be later at least conditionally accessed to permit a review of the information to thereby assess the repair to the particular vehicle.

2. The method of claim 1 wherein the vehicle repair completion documentation includes, at least in part, a final repair invoice.

3. The method of claim 2 wherein the final repair invoice documents, at least in part:
parts used to repair the particular vehicle;
labor costs to repair the particular vehicle;
painting costs associated with repairing the particular vehicle; and
miscellaneous sublet charges associated with repairing the particular vehicle.

4. The method of claim 1 wherein the statement includes, at least in part, at least one estimated repair parameter corresponding to repair of the particular vehicle.

5. The method of claim 4 wherein the estimated repair parameter comprises at least one of:
an estimated monetary cost of the repair; and
an estimated time to effect the repair.

6. The method of claim 1 wherein the statement comprises, at least in part, a compilation of repair procedures.

7. The method of claim 1 wherein the particular vehicle comprises a terrestrial vehicle.

8. The method of claim 7 wherein the unique vehicle identifier comprises a Vehicular Identification Number (VIN).

9. The method of claim 1 wherein the information regarding the vehicle repair completion documentation comprises, at least in part, at least one photographic image of the particular vehicle that depicts at least some aspect of the repair.

10. The method of claim 9 wherein the at least one photographic image of the particular vehicle that depicts at least some aspect of the repair evidences attending to a given one of the sub-tasks.

11. An apparatus configured to facilitate repairing a particular vehicle having a unique vehicle identifier assigned thereto by a manufacturer of the particular vehicle, the apparatus comprising:
a control circuit configured to:
provide a statement corresponding to a pending repair of the particular vehicle and to securely storing the statement in inviolate electronic storage in correlation with the unique vehicle identifier;
securely store information regarding ordered parts to specifically use to repair the particular vehicle per the statement in the inviolate electronic storage in correlation with the unique vehicle identifier;
securely store in the inviolate electronic storage in correlation with the unique vehicle identifier information regarding completion of at least some of a series of specified sub-tasks that define, at least in part, repairing the particular vehicle;
prepare vehicle repair completion documentation and securely store information regarding the vehicle repair completion documentation in the inviolate electronic storage in correlation with the unique vehicle identifier;
such that any of the information securely stored in the inviolate electronic storage in correlation with the unique vehicle identifier can be later at least conditionally accessed to permit a review of the information to thereby assess the repair to the particular vehicle.

12. The apparatus of claim 11 wherein the vehicle repair completion documentation includes, at least in part, a final repair invoice.

13. The apparatus of claim 12 wherein the final repair invoice documents, at least in part:
parts used to repair the particular vehicle;
labor costs to repair the particular vehicle;
painting costs associated with repairing the particular vehicle; and
miscellaneous sublet charges associated with repairing the particular vehicle.

14. The apparatus of claim 11 wherein the statement includes, at least in part, at least one estimated repair parameter corresponding to repair of the particular vehicle.

15. The apparatus of claim 14 wherein the estimated repair parameter comprises at least one of:
an estimated monetary cost of the repair; and
an estimated time to effect the repair.

16. The apparatus of claim 11 wherein the statement comprises, at least in part, a compilation of repair procedures.

17. The apparatus of claim 11 wherein the particular vehicle comprises a terrestrial vehicle.

18. The apparatus of claim 17 wherein the unique vehicle identifier comprises a Vehicular Identification Number (VIN).

19. The apparatus of claim 11 wherein the information regarding the vehicle repair completion documentation comprises, at least in part, at least one photographic image of the particular vehicle that depicts at least some aspect of the repair.

20. The apparatus of claim 19 wherein the at least one photographic image of the particular vehicle that depicts at least some aspect of the repair evidences attending to a given one of the sub-tasks.
